(19) United States
(12) Patent Application Publication
(10) Pub. No.: US 2024/0413422 A1
(43) Pub. Date: Dec. 12, 2024

(54) HEATING A MIXED-CHEMISTRY BATTERY PACK OF A VEHICLE

(71) Applicant: GM GLOBAL TECHNOLOGY OPERATIONS LLC, DETROIT, MI (US)

(72) Inventors: Jun-mo Kang, Ann Arbor, MI (US); Shuonan Xu, Troy, MI (US); Hanho Yun, Oakland Twp, MI (US)

(21) Appl. No.: 18/330,704

(22) Filed: Jun. 7, 2023

(51) Int. Cl. H01M 10/615; B60L 58/12; B60L 58/27; H01M 10/625; H01M 10/63

(52) U.S. Cl. CPC H01M 10/615; B60L 58/12; B60L 58/27; H01M 10/625; H01M 10/63; H01M 2220/20

(57) ABSTRACT

A vehicle having a mixed chemistry battery having first and second battery modules, a temperature sensor, a battery heating system configured to selectively heat the first battery module and/or the second battery module, and a controller. The controller configured to monitor the temperature of the first battery module, activate the heating system based on a determination that the temperature is below a minimum threshold value, monitor a first state-of-charge (SoC) of the first battery module and the second battery module, calculate a minimum set-point temperature for the first battery module based on the first SoC, the second SoC, and a maximum current load of the first battery module, and instruct the battery heating system to provide a portion of a total available heating power of the battery heating system to the first battery module and a remainder of the total available heating power to the second battery module.

### INTRODUCTION

The disclosure relates to heating a mixed-chemistry battery. More specifically, the disclosure relates to a vehicle having a mixed-chemistry battery that includes at least two battery modules that are adaptively heated.

Lithium-ion batteries are used in a variety of applications, from electric vehicles to residential batteries to grid-scale applications. In general, the term lithium-ion battery refers to a wide array of battery chemistries that each charge and discharge using reactions from a lithiated metal oxide cathode and a graphite anode. Two of the more commonly used lithium-ion chemistries are nickel manganese cobalt (NCM) and lithium iron phosphate (LFP). In general, NCM batteries have better performance than LFP batteries at very low temperatures, (i.e., temperatures below approximately negative twenty degrees Celsius).

### SUMMARY

In one exemplary embodiment, a method for adaptively heating a mixed chemistry battery having a first battery module and a second battery module is provided. The method includes monitoring a temperature of the first battery module and activating a heating system configured to heat one or more of the first battery module and the second battery module based on a determination that the temperature of the first battery module is below a minimum threshold value. The method also includes monitoring a first state-of-charge (SoC) of the first battery module, monitoring a second state-of-charge of the second battery module, and calculating a minimum set-point temperature for the first battery module based on the first SoC, the second SoC, and a maximum current load of the first battery module. The method further includes providing a portion of a total available heating power of the heating system to the first battery module and a remainder of the total available heating power of the heating system to the second battery module. The portion is determined based at least in part on a difference between the temperature of the first battery module and the minimum set-point temperature for the first battery module.

In addition to the one or more features described herein the method also includes calculating a minimum set-point SoC of the first battery module based on the first SoC, the temperature, and the maximum current load of the first battery module. The mixed chemistry battery is configured to provide power to a load from the first battery module based on a determination that the first SoC is greater than the minimum set-point SoC and is configured to provide power to the load from the second battery module based on a determination that the first SoC is has reached the minimum set-point SoC.

In addition to the one or more features described herein the portion of the total available heating power provided to the first battery module dynamically changes based on monitored changes to the first SoC.

In addition to the one or more features described herein the first battery module has a first chemistry and the second battery module has a second chemistry, that is different than the first chemistry.

In addition to the one or more features described herein the first chemistry has a greater energy density than the second chemistry.

In addition to the one or more features described herein the method also includes deactivating the heating system based on a determination that the temperature of the first battery module has reached a maximum threshold value.

In addition to the one or more features described herein the maximum current load of the first battery module is determined based on a first chemistry of the first battery module and a configuration of the first battery module.

In addition to the one or more features described herein the first battery module is connected to the second battery module in parallel by a direct current (DC)/DC converter.

In one exemplary embodiment, a vehicle is provided. The vehicle includes a mixed chemistry battery having a first battery module and a second battery module, a temperature sensor, a battery heating system configured to selectively heat one or more of the battery module and the second battery module, and a controller. The controller is configured to monitor, via the temperature sensor, a temperature of the first battery module and activate the heating system based on a determination that the temperature of the first battery module is below a minimum threshold value. The controller is also configured to monitor a first state-of-charge (SoC) of the first battery module, monitor a second state-of-charge (SoC) of the second battery module, and calculate a minimum set-point temperature for the first battery module based on the first SoC, the second SoC, and a maximum current load of the first battery module. The controller is further configured to instruct the battery heating system to provide a portion of a total available heating power of the battery heating system to the first battery module and a remainder of the total available heating power of the heating system to the second battery module. The portion is determined based at least in part on a difference between the temperature of the first battery module and the minimum set-point temperature for the first battery module.

In addition to the one or more features described herein the first battery module is connected to the second battery module in parallel by a direct current (DC)/DC converter.

In addition to the one or more features described herein the portion of the total available heating power provided to the first battery module dynamically changes based on monitored changes to the first SoC.

In addition to the one or more features described herein the first battery module has a first chemistry and the second battery module has a second chemistry, that is different than the first chemistry.

In addition to the one or more features described herein the first chemistry has a greater energy density than the second chemistry.

In addition to the one or more features described herein the maximum current load of the first battery module is determined based on a first chemistry of the first battery module and a configuration of the first battery module.

In addition to the one or more features described herein the controller is also configured to calculate a minimum set-point SoC of the first battery module based on the first SoC, the temperature, and the maximum current load of the first battery module. The mixed chemistry battery is configured to provide power to a load from the first battery module based on a determination that the first SoC is greater than the minimum set-point SoC and is configured to provide power to the load from the second battery module based on a determination that the first SoC is has reached the minimum set-point SoC.

In addition to the one or more features described herein the controller is also configured to deactivate the heating system based on a determination that the temperature of the first battery module has reached a maximum threshold value.

In another exemplary embodiment, a vehicle is provided. The vehicle includes a mixed chemistry battery having a first battery module, a second battery module, and a direct current (DC)/DC converter connected to both the first battery module and the second battery module, wherein the first chemistry has a greater energy density than the second chemistry, a temperature sensor, a battery heating system configured to selectively heat one or more of the battery module and the second battery module, and a controller. The controller is configured to monitor, via the temperature sensor, a temperature of the first battery module and activate the heating system based on a determination that the temperature of the first battery module is below a minimum threshold value. The controller is also configured to monitor a first state-of-charge (SoC) of the first battery module, monitor a second state-of-charge (SoC) of the second battery module, and calculate a minimum set-point temperature for the first battery module based on the first SoC, the second SoC, and a maximum current load of the first battery module. The controller is further configured to instruct the battery heating system to provide a portion of a total available heating power of the battery heating system to the first battery module and a remainder of the total available heating power of the heating system to the second battery module. The portion is determined based at least in part on a difference between the temperature of the first battery module and the minimum set-point temperature for the first battery module.

In addition to the one or more features described herein the controller is also configured to calculate a minimum set-point SoC of the first battery module based on the first SoC, the temperature, and the maximum current load of the first battery module. The mixed chemistry battery is configured to provide power to a load from the first battery module based on a determination that the first SoC is greater than the minimum set-point SoC and is configured to provide power to the load from the second battery module based on a determination that the first SoC is has reached the minimum set-point SoC.

In addition to the one or more features described herein the controller is also configured to deactivate the heating system based on a determination that the temperature of the first battery module has reached a maximum threshold value.

In addition to the one or more features described herein the maximum current load of the first battery module is determined based on a first chemistry of the first battery module and a configuration of the first battery module.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic diagram of a vehicle in accordance with an exemplary embodiment;

FIG. 2 is a block diagram illustrating a portion of an electrical system of a vehicle in accordance with an exemplary embodiment;

FIGS. 3A and 3B are graphs illustrating the relationship between the voltage of a battery module and the state of charge of the battery modules at different temperatures;

FIG. 4A is a graph illustrating the change of state of charge of a first battery module and a second battery module during the use of a mixed-chemistry battery without heating the mixed-chemistry battery;

FIG. 4B is a graph illustrating the change of state of charge of a first battery module and a second battery module during the use of a mixed-chemistry battery while heating the mixed-chemistry battery at a first rate;

FIG. 4C is a graph illustrating the change of state of charge of a first battery module and a second battery module during the use of a mixed-chemistry battery while heating the mixed-chemistry battery at a second rate;

FIG. 5A is a graph illustrating the change in the temperature of a first battery module and a second battery module of a mixed-chemistry battery using an adaptive heating method in accordance with an exemplary embodiment;

FIG. 5B is a graph illustrating the heating power provided to a first battery module and a second battery module of a mixed-chemistry battery using an adaptive heating method in accordance with an exemplary embodiment; and

FIG. 6 is a flowchart illustrating a method for adaptively heating a mixed-chemistry battery of a vehicle in accordance with an exemplary embodiment.

### DETAILED DESCRIPTION

The following description is merely exemplary in nature and is not intended to limit the present disclosure, its application or uses. Various embodiments of the disclosure are described herein with reference to the related drawings. Alternative embodiments of the disclosure can be devised without departing from the scope of the claims. Various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship.

Turning now to an overview of the aspects of the disclosure, embodiments of the disclosure include a vehicle having a mixed chemistry battery that includes a first battery module and a second battery module. In exemplary embodiments, the vehicle is configured to draw power from the first battery module until the first battery module reaches a cutoff state-of-charge (SoC) value and then to draw power from the second battery module. Since the first battery module will be discharged and recharged more frequently than the second battery module, the first battery module is configured to have a higher cycle life than the second battery module. In some embodiments, the second battery module has a higher energy density than the first battery module.

As used herein, a mixed chemistry battery is a lithium-ion battery that includes battery cells that have at least two different chemistries. Two of the more commonly used lithium-ion chemistries are nickel manganese cobalt (NCM) and lithium iron phosphate (LFP). In general, LFP batteries are less expensive to manufacture than NCM batteries and NCM batteries have higher power rating and energy density compared to LFP batteries and NCM batteries have better performance than LFP batteries at very low temperatures, (i.e., temperatures below approximately negative twenty degrees Celsius).

Since the first battery module will be used to provide energy to the vehicle during the initial use of the vehicle, it is desirable to heat the first battery module at a faster rate than the second battery module. In exemplary embodiments, the vehicle includes a heating system that is configured to selectively heat the battery modules. In exemplary embodiments, the amount of heating power provided to the first battery module and the second battery module by the heating system dynamically changes based at least in part on an SoC of the first battery module, an SoC of the second battery module, and a maximum current load of the first battery module.

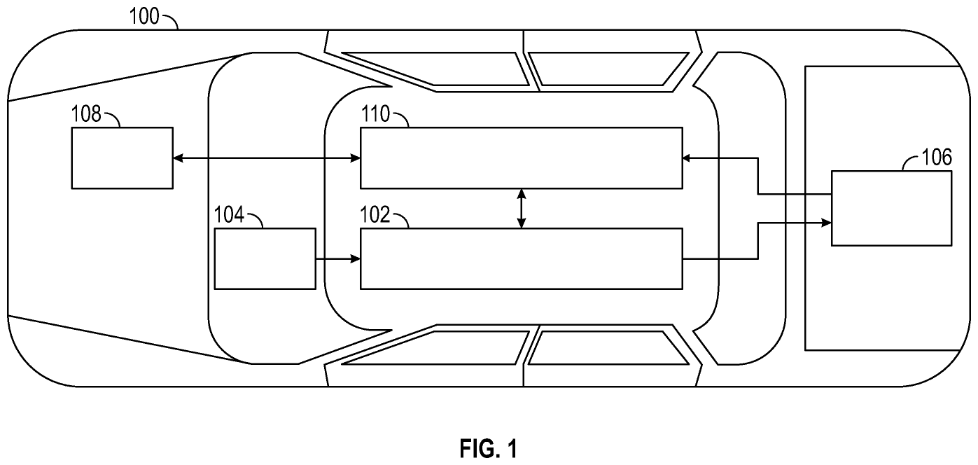

Referring now to FIG. 1, a schematic diagram of a vehicle 100 that includes mixed chemistry battery 110 according to one or more embodiments is shown. The vehicle 100 also includes a controller 102, a temperature sensor 104, a battery heating system 106, and an electric motor 108. In exemplary embodiments, the controller 102 is one of a general-purpose processor, a Field programable gate array (FPGA), an application-specific integrated circuit (ASIC), or the like. The controller 102 is configured to monitor the temperature sensor 104 and the SoC of the modules of the mixed chemistry battery 110 and to responsively control the battery heating system 106. The electric motor 108 is configured to provide propulsion to the vehicle 100 by drawing power from the mixed chemistry battery 110.

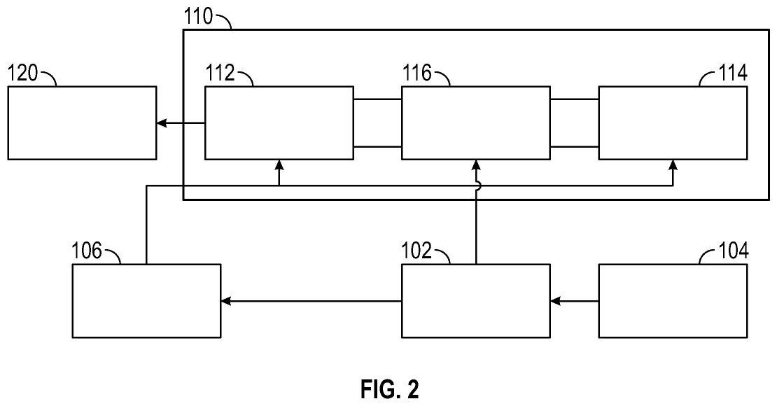

Referring now to FIG. 2 a block diagram of a portion of an electrical system of a vehicle having a mixed chemistry battery 110 in accordance with an exemplary embodiment is shown. As illustrated, the mixed chemistry battery 110 includes a first battery module 112 and a second battery module 114 that are connected to each other in parallel via a direct current (DC)/DC converter 116. In exemplary embodiments, the DC/DC converter 116 is a bi-directional buck or boost converter. In exemplary embodiments, the first battery module 112 is configured to maintain a voltage level that is higher than the voltage level of the second battery module 114. During the use of the mixed chemistry battery 110, power is provided to load 120 from the first battery module 112 until the first battery module reaches a cutoff state-of-charge (SoC) value and then power is provided to load 120 from the second battery module 114.

In exemplary embodiments, the controller 102 is configured to monitor the temperature sensor 104, a SoC of the first battery module, and an SoC of the second battery module 114. The controller 102 is also configured to calculate a minimum set-point temperature for the first battery module 112 based on the SoC of the first battery module 112, the SoC of the second battery module 114, and the maximum current load of the first battery module 112. In exemplary embodiments, the minimum set-point temperature for the first battery module 112 is the minimum temperature at which power should be provided to load 120 from the first battery module 112. The controller 102 is further configured to control the battery heating system 106 to instruct the battery heating system 106 to provide a portion of the total available heating power of the battery heating system 106 to the first battery module 112 and a remainder of the total available heating power of the battery heating system 106 to the second battery module 114. In exemplary embodiments, the portion of the total available heating power of the battery heating system 106 provided to the first battery module 112 is determined based at least in part on a difference between the temperature and the minimum set-point temperature for the first battery module 112.

In exemplary embodiments, the controller 102 is further configured to calculate a minimum set-point SoC of the first battery module 112 based on the SoC of the first battery module 112, the temperature, and the maximum current load of the first battery module 112. The minimum set-point SoC of the first battery module 112 is the minimum SoC of the first battery module 112 at which power should be provided to load 120 from the first battery module 112. Once the monitored SoC of the first battery module 112 reaches the minimum set-point SoC of the first battery module 112, the mixed chemistry battery 110 will stop providing power from the first battery module 112 to load 120 and will begin providing power from the second battery module 114 to load 120.

In exemplary embodiments, the heating system 106 includes one or more of a resistance heating system, heat pumps, or other thermal management systems. In one embodiment, the resistance heating system includes resistors disposed in each battery module that are used to selectively heat each battery module by passing current through the resistors.

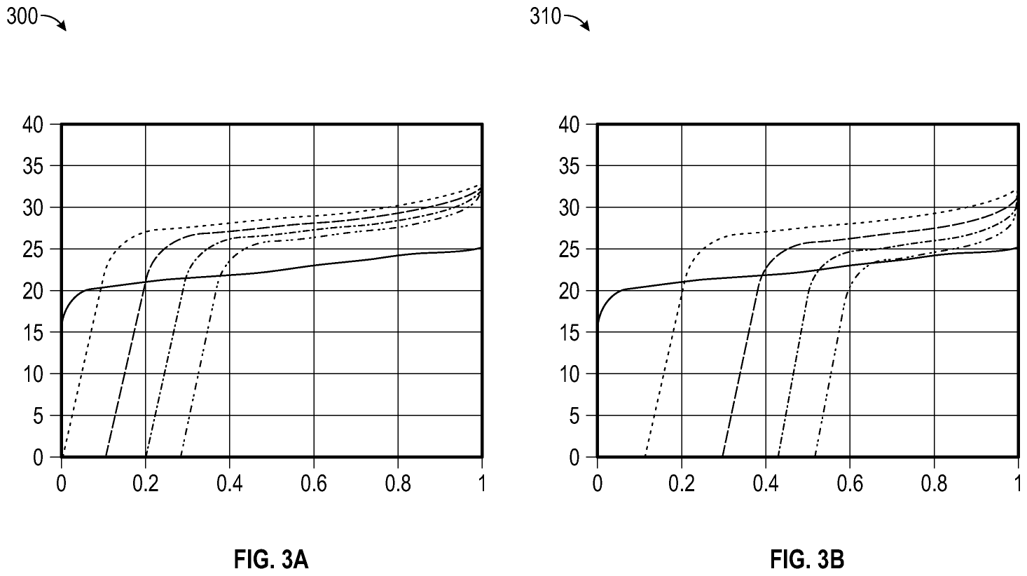

Referring now to FIGS. 3A and 3B, graphs 300, 310 illustrating the relationship between the voltage of a lithium-ion battery module and the state of charge of lithium-ion battery modules at different temperatures are shown. Graph 300 illustrates the relationship between the voltage of a lithium-ion battery module and the state of charge of the lithium-ion battery module at twenty degrees Celsius (C) when the battery module has a range of load currents from zero to two-hundred amperes (A). Graph 300 illustrates the relationship between the voltage of a lithium-ion battery module and the state of charge of the lithium-ion battery module at zero degrees C. when the battery module has a range of load currents from zero to two-hundred amperes (A). As shown by the difference in graphs 300 and 310 the performance of the lithium-ion battery modules degrades as the temperature of the lithium-ion battery modules decreases. Accordingly, it is often desirable to heat lithium-ion battery modules operating in a very cold environment, (i.e., less than zero degrees C.), to improve the performance of the lithium-ion battery modules.

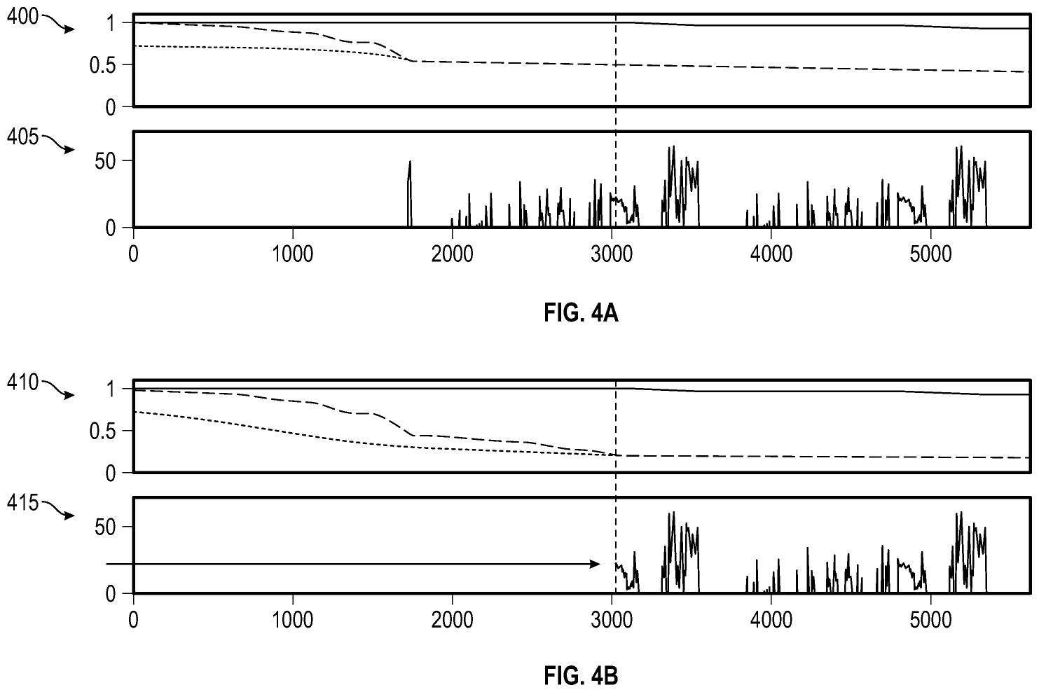

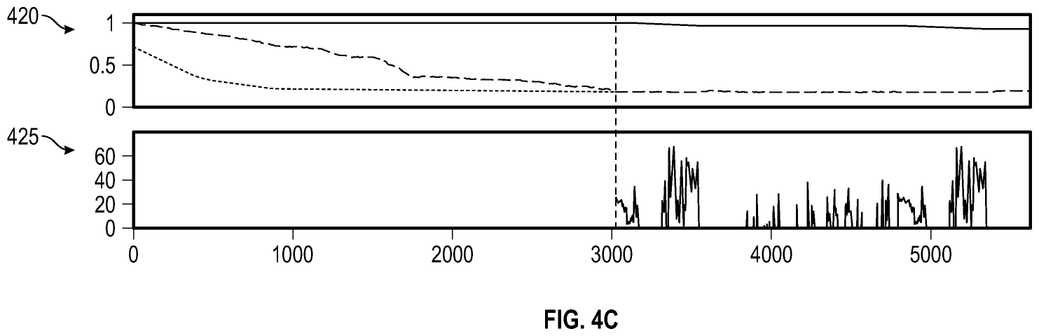

Referring now to FIG. 4A, a graph 400 illustrating the change of the state of charge of a first battery module and the state of charge of a second battery module during the use of a mixed-chemistry battery without heating the mixed-chemistry battery is shown. As illustrated, the state of charge of a first battery module begins to decrease as power is drawn from the first battery module. The state of charge of the first battery module decreases until it reaches the minimum set-point SoC for the first battery module, at approximately 1700 seconds. Once the state of charge of the first battery module reaches the minimum set-point SoC for the first battery module, the current begins flowing through the DC/DC converter connecting the first battery module and the second battery module as shown in graph 405 as power is drawn from the second battery module to provide energy to the vehicle and to charge the first battery module.

Referring now to FIG. 4B, a graph 410 illustrating the change of the state of charge of a first battery module and the state of charge of a second battery module during the use of a mixed-chemistry battery while heating the mixed-chemistry battery at a first rate is shown. In one embodiment, the first rate is approximately one-half degree C. per minute of heating. As illustrated, the state of charge of a first battery module begins to decrease as power is drawn from the first battery module. The state of charge of the first battery module decreases until it reaches the minimum set-point SoC for the first battery module, at approximately 3000 seconds. Due to the heating of the battery module, the state of charge of the first battery module does not reach the minimum set-point SoC for the first battery module until approximately 1300 seconds later. Once the state of charge of the first battery module reaches the minimum set-point SoC for the first battery module, the current begins flowing through the DC/DC converter connecting the first battery module and the second battery module as shown in graph 415 as power is drawn from the second battery module to provide energy to the vehicle and to charge the first battery module.

Referring now to FIG. 4C, a graph 420 illustrating the change of the state of charge of a first battery module and the state of charge of a second battery module during the use of a mixed-chemistry battery while heating the mixed-chemistry battery at a second rate is shown. In one embodiment, the second rate is approximately two degrees C. per minute of heating. As illustrated, the state of charge of the first battery module begins to decrease as power is drawn from the first battery module. The state of charge of the first battery module decreases until it reaches the minimum set-point SoC for the first battery module, at approximately 3000 seconds.

Notably, due to the faster heating rate, the minimum set-point SoC shown in graph 420 decreases at a much higher rate than the minimum set-point SoC shown in graph 410. However, the state of charge of first battery module reaches the minimum set-point SoC for the first battery module, at approximately 3000 seconds, in both graphs 410 and 420. Accordingly, the extra energy consumed by increasing the heating rate from the first rate to the second rate will not have any impact on when the SoC of the first battery module reaches the minimum set-point SoC for the first battery module. However, increasing the heating rate from zero, as shown in graph 400, to the first rate, as shown in graph 410, does result in delaying the time at which the SoC of the first battery module reaches the minimum set-point SoC for the first battery module.

Accordingly, it is desirable to control the amount of heating power that is provided to the first battery module to maximize the time until the SoC of the first battery module reaches the minimum set-point SoC for the first battery module while minimizing the amount of energy spent heating the first battery module. Exemplary embodiments utilize an adaptive heating method that controls the rate of heating to the first battery module by calculating a minimum set-point temperature for the first battery module based on the SoC of the first battery module, SoC of the second battery module and the maximum current load of the first battery module. The heating power of the battery heating system is then divided between the first battery module and the second battery module by providing a portion of the total available heating power of the heater to the first battery module and a remainder of the total available heating power of the heater to the second battery module. The portion of the total available heating power of the heater to the first battery module is determined based at least in part on a difference between the temperature of the first battery module and the minimum set-point temperature for the first battery module.

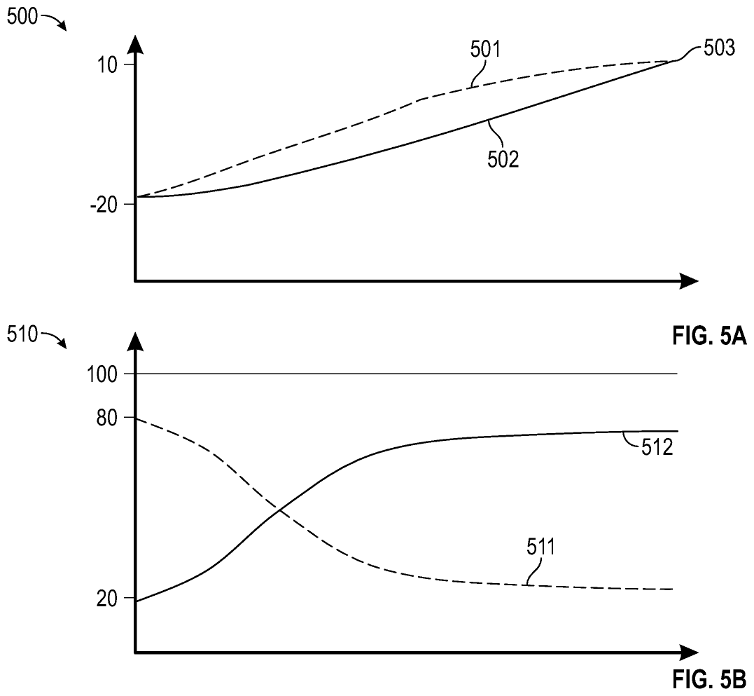

Referring now to FIG. 5A and 5B, a graph 500 illustrating the change in the temperature of a first battery module and a second battery module of a mixed-chemistry battery using an adaptive heating method and a graph 510 illustrating the heating power provided to a first battery module and a second battery module of a mixed-chemistry battery using an adaptive heating method in accordance with an exemplary embodiment are respectively shown. As best illustrated by graph 500, a first temperature 501 of the first battery module and a second temperature 502 of the second battery module both being at approximately negative twenty degrees Celsius (−20 C.) and increase at different rates until reaching a maximum threshold temperature 503, shown as approximately ten degrees Celsius (10 C.). In exemplary embodiments, the maximum threshold temperature is the temperature at which the heating system for the mixed chemistry battery is deactivated.

As best illustrated by graph 510, a first percentage of heating power 511 that is provided to the first battery module begins at approximately eighty percent and decreases to approximately twenty percent. Likewise, a second percentage of heating power 512 that is provided to the second battery module begins at approximately twenty percent and increases to approximately eighty percent. In exemplary embodiments, the different rates of change of the temperature of the first battery module and the temperature of the second battery module are a result of the changing percentages of heating power applied to the first battery module and the second battery module. In exemplary embodiments, the percentage of the heating power 511 provided to the first battery module is controlled to maximize a duration that the SoC of the first battery module exceeds the minimum set-point SoC for the first battery module while minimizing the amount of energy spent heating the first battery module.

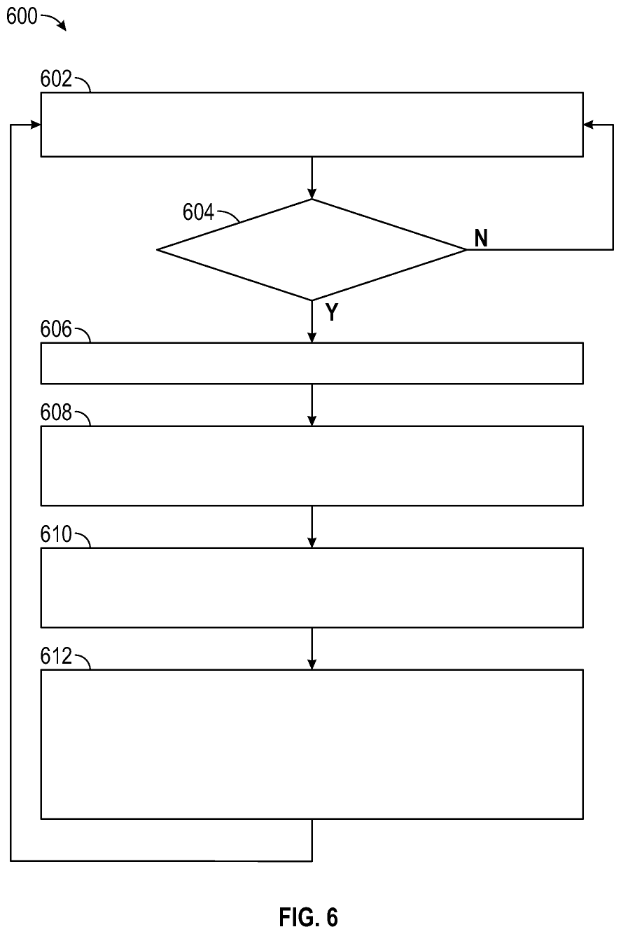

Referring now to FIG. 6, a flowchart 600 illustrating a method for adaptively heating a mixed-chemistry battery having a first battery module and a second battery module in accordance with an exemplary embodiment is shown. In exemplary embodiments, the first battery module has a first chemistry and the second battery module has a second chemistry, which is different than the first chemistry. In one embodiment, the first chemistry has a greater energy density than the second chemistry. In exemplary embodiments, the first battery module is connected to the second battery module in parallel by a direct current (DC)/DC converter.

The method 600 beings at block 602 by monitoring the temperature of the first battery module of the mixed-chemistry battery. Next, at decision block 604, it is determined whether the temperature of the first battery module is less than a threshold minimum value. If the temperature of the first battery module is less than a threshold minimum value, the method 600 proceeds to block 606, and a heating system for the mixed chemistry battery is activated. In exemplary embodiments, the heating system for the mixed chemistry battery is able to selectivity and independently heat one or both of the first battery module and the second battery module at different rates.

Next, at block 608, the method 600 includes monitoring a first state-of-charge (SoC) of the first battery module and a second state-of-charge (SoC) of the second battery module. The method 600 also includes calculating a minimum set-point temperature for the first battery module based on the first SoC, the second SoC and the maximum current load of the first battery module, at block 610. In exemplary embodiments, the maximum current load of the first battery module is determined based on the configuration and chemistry of the first battery module. Once the minimum set-point temperature for the first battery module is calculated, the method 600 proceeds to block 612 and includes providing a portion of the total available heating power of the heating system to the first battery module and a remainder of the total available heating power of the heater to the second battery module.

In exemplary embodiments, the portion of the total available heating power of the heating system provided to the first battery module is determined based at least in part on a difference between the temperature of the first battery module and the minimum set-point temperature for the first battery module. In exemplary embodiments, the portion of the total available heating power of the heating system that is provided to the first battery module dynamically changes based on monitored changes to the SoC of the first battery module. In exemplary embodiments, the method further includes deactivating the heating system based on a determination that the temperature of the first battery module has reached a maximum threshold value.

In exemplary embodiments, the mixed chemistry battery is configured to provide power to a load from the first battery module based on a determination that the first SoC is greater than the minimum set-point SoC and is configured to provide power to the load from the second battery module based on a determination that the first SoC is has reached the minimum set-point SoC. The minimum set-point SoC of the first battery module is calculated based on the first SoC, the temperature, and the maximum current load of the first battery module.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method for adaptively heating a mixed chemistry battery having a first battery module and a second battery module, the method comprising:
monitoring a temperature of the first battery module;
activating a heating system configured to heat one or more of the first battery module and the second battery module based on a determination that the temperature of the first battery module is below a minimum threshold value;
monitoring a first state-of-charge (SoC) of the first battery module;
monitoring a second SoC of the second battery module;
calculating a minimum set-point temperature for the first battery module based on the first SoC, the second SoC, and a maximum current load of the first battery module; and
providing a portion of a total available heating power of the heating system to the first battery module and a remainder of the total available heating power of the heating system to the second battery module,
wherein the portion is determined based at least in part on a difference between the temperature of the first battery module and the minimum set-point temperature for the first battery module.

2. The method of claim 1, further comprising:
calculating a minimum set-point SoC of the first battery module based on the first SoC, the temperature, and the maximum current load of the first battery module,
wherein the mixed chemistry battery is configured to provide power to a load from the first battery module based on a determination that the first SoC is greater than the minimum set-point SoC and is configured to provide power to the load from the second battery module based on a determination that the first SoC is has reached the minimum set-point SoC.

3. The method of claim 1, wherein the portion of the total available heating power provided to the first battery module dynamically changes based on monitored changes to the first SoC.

4. The method of claim 1, wherein the first battery module has a first chemistry and the second battery module has a second chemistry, that is different than the first chemistry.

5. The method of claim 4, wherein the first chemistry has a greater energy density than the second chemistry.

6. The method of claim 1, further comprising deactivating the heating system based on a determination that the temperature of the first battery module has reached a maximum threshold value.

7. The method of claim 1, wherein the maximum current load of the first battery module is determined based on a first chemistry of the first battery module and a configuration of the first battery module.

8. The method of claim 1, wherein the first battery module is connected to the second battery module in parallel by a direct current (DC)/DC converter.

9. A vehicle comprising:
a mixed chemistry battery having a first battery module and a second battery module;
a temperature sensor;
a battery heating system configured to selectively heat one or more of the first battery module and the second battery module; and
a controller configured to:
monitor, via the temperature sensor, a temperature of the first battery module;
activate the heating system based on a determination that the temperature of the first battery module is below a minimum threshold value;
monitor a first state-of-charge (SoC) of the first battery module;
monitor a second SoC of the second battery module;
calculate a minimum set-point temperature for the first battery module based on the first SoC, the second SoC, and a maximum current load of the first battery module; and
instruct the battery heating system to provide a portion of a total available heating power of the battery heating system to the first battery module and a remainder of the total available heating power of the heating system to the second battery module,
wherein the portion is determined based at least in part on a difference between the temperature of the first battery module and the minimum set-point temperature for the first battery module.

10. The vehicle of claim 9, wherein the first battery module is connected to the second battery module in parallel by a direct current (DC)/DC converter.

11. The vehicle of claim 9, wherein the portion of the total available heating power provided to the first battery module dynamically changes based on monitored changes to the first SoC.

12. The vehicle of claim 9, wherein the first battery module has a first chemistry and the second battery module has a second chemistry, that is different than the first chemistry.

13. The vehicle of claim 12, wherein the first chemistry has a greater energy density than the second chemistry.

14. The vehicle of claim 9, wherein the maximum current load of the first battery module is determined based on a first chemistry of the first battery module and a configuration of the first battery module.

15. The vehicle of claim 9, wherein the controller is further configured to:
calculate a minimum set-point SoC of the first battery module based on the first SoC, the temperature, and the maximum current load of the first battery module,
wherein the mixed chemistry battery is configured to provide power to a load from the first battery module based on a determination that the first SoC is greater than the minimum set-point SoC and is configured to provide power to the load from the second battery module based on a determination that the first SoC is has reached the minimum set-point SoC.

16. The vehicle of claim 9, wherein the controller is further configured to deactivate the heating system based on a determination that the temperature of the first battery module has reached a maximum threshold value.

17. A vehicle comprising:
a mixed chemistry battery having a first battery module, a second battery module, and a direct current (DC)/DC converter connected to both the first battery module and the second battery module, wherein a first chemistry of the first battery module has a greater energy density than a second chemistry of the second battery module;
a temperature sensor;
a battery heating system configured to selectively heat one or more of the first battery module and the second battery module; and
a controller configured to:
monitor, via the temperature sensor, a temperature of the first battery module;
activate the heating system based on a determination that the temperature of the first battery module is below a minimum threshold value;
monitor a first state-of-charge (SoC) of the first battery module;
monitor a second SoC of the second battery module;
calculate a minimum set-point temperature for the first battery module based on the first SoC, the second SoC, and a maximum current load of the first battery module; and
instruct the battery heating system to provide a portion of a total available heating power of the battery heating system to the first battery module and a remainder of the total available heating power of the heating system to the second battery module,
wherein the portion is determined based at least in part on a difference between the temperature of the first battery module and the minimum set-point temperature for the first battery module.

18. The vehicle of claim 17, wherein the controller is further configured to:
calculate a minimum set-point SoC of the first battery module based on the first SoC, the temperature, and the maximum current load of the first battery module,
wherein the mixed chemistry battery is configured to provide power to a load from the first battery module based on a determination that the first SoC is greater than the minimum set-point SoC and is configured to provide power to the load from the second battery module based on a determination that the first SoC is has reached the minimum set-point SoC.

19. The vehicle of claim 17, wherein the controller is further configured to deactivate the heating system based on a determination that the temperature of the first battery module has reached a maximum threshold value.

20. The vehicle of claim 17, wherein the maximum current load of the first battery module is determined based on the first chemistry of the first battery module and a configuration of the first battery module.
